(19) United States
(12) Patent Application Publication
(10) Pub. No.: US 2009/0069461 A1
(43) Pub. Date: Mar. 12, 2009

(54) Additive for Cement Composition Containing Fly Ash and Cement Composition

(75) Inventors: Tatsuya Matsui, Tokyo (JP); Sae Kishi, Kawasaki-shi (JP)

Correspondence Address: OLIFF & BERRIDGE, PLC, P.O. BOX 320850, ALEXANDRIA, VA, 22320-4850, US

(73) Assignee: NOF CORPORATION, Tokyo (JP)

(21) Appl. No.: 12/086,694

(22) PCT Filed: Dec. 26, 2006
(86) PCT No.: PCT/JP2006/326338

§ 371 Date: Aug. 28, 2008

(30) Foreign Application Priority Data
Dec. 27, 2005 (JP) 2005-374766

(51) Int. Cl. C04B 24/24; C08L 33/02

(52) U.S. Cl. 524/5; 525/190

(57) ABSTRACT

An object is, in a fly ash-containing cement composition, to disperse fly ash well with addition of a small amount of additive to prevent the deviation of flowability of the cement composition due to the change of unburned carbon content. An additive for a fly ash-containing cement composition includes (A) a nitrogenous polyoxyalkylene derivative represented by formula (1) and (B) a polycarboxylic acid series copolymer having a polyoxyalkylene chain as essential components. R¹ represents hydrogen atom or a hydrocarbon group having 1 to 22 carbon atom, R² represents alkylene group having 1 to 4 carbon atom, A¹O represents one or two or more oxyalkylene groups having 2 to 4 carbon atoms, which may be block or random in the case of two or more kinds of oxyalkylene groups, p=0 to 20, q=0 to 20, r=1 to 10, s=0 to 2 and t=0 to 2.

### FIELD OF THE INVENTION

The present invention relates to an additive for fly ash-containing cement composition containing a specific nitrogenous polyoxyalkylene derivative and a specific copolymer of the polyoxyalkylene derivative, and a cement composition containing the additive.

### BACKGROUND ARTS

From the viewpoint of protection of environment and of resources, in recent years, it has been drawn attention to effectively use fly ash generated from a coal thermal power plant or the like as one of recycling of industrial by-products. At present, a considerable portion of fly ash is used again as a raw material of cement or disposed by reclaimation. As the amount of fly ash has been increased years by years, however, the demand of cement is substantially constant. It has been more difficult to assure large-scale reclaimed lands for fly ash. It has been thereby demanded effective reuse of fly ash as resources in fields such as cement concrete, which is one of main use of fly ash for recycling.

When fly ash is used as the resource in cement industry, unburned carbon content in the fly ash is problematic. In the case that fly ash containing a substantial amount of unburned carbon content is used in cement composition, cement additives such as AE agent and water reducing agent may be adsorbed onto the unburned carbon content. The effects may thus be prohibited or not fully exhibited. It is thus necessary to use the cement additive in an excess amount so as to fully exhibit its effects. The addition of excess amount of the cement additive may result in the time-dependent change of air amount, retardation of setting, deterioration of workability and of physical properties after the setting. Further, the unburned carbon content of fly ash may fluctuate depending on the kind of coal or burning temperature. In the case that fly ash is used for cement composition, appropriate amount of water reducing agent may be thereby fluctuated. Such fluctuation has been problematic in effectively utilizing fly ash.

According to Japanese patent publication No. 2001-213648A, for solving the above problems, a specific nitrogenous polyoxyalkylene derivative and polycarboxylic acid compound are used to provide a dispersion composition for dispersing coal ash well and effectively used for coal ash having a large content of unburned carbon.

### SUMMARY OF THE INVENTION

According to the dispersion composition described in Japanese patent publication No. 2001-213648A, it is provided a dispersion composition for dispersing coal ash well and effectively used for coal ash having a large content of unburned carbon. In the case of fly ash, however, the amount of unburned carbon may be changed depending on the site and lot of fly ash. According to the method described in Japanese patent publication No. 2001-213648A, in the case of fly ash, the deviation of flowability of cement composition proved to be considerable, so that further improvement is necessary.

An object of the prevent invention is, in a fly ash-containing cement composition, to disperse fly ash well with addition of a small amount of additive to prevent the deviation of flowability of the cement composition due to the change of unburned carbon content.

That is, the present invention provides an additive for a fly ash-containing cement composition, said additive comprising the following (A) and (B) components as essential components.

(A) a nitrogenous polyoxyalkylene derivative represented by the following formula (1).

(B) a polycarboxylic acid series copolymer having a polyoxyalkylene chain.

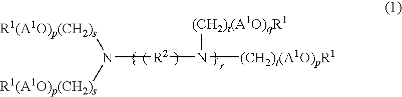

(wherein R¹ represents hydrogen atom or a hydrocarbon group having 1 to 22 carbon atoms, R² represents an alkylene group having 1 to 4 carbon atom, A¹O represents one or two or more oxyalkylene group having 2 to 4 carbon atoms, which may be block or random in the case of two or more kinds of oxyalkylene groups, p=0 to 20, q=0 to 20, r=1 to 10, s=0 to 2 and t=0 to 2.)

According to a preferred embodiment, (B) the polycarboxylic acid series copolymer having a polyoxyalkylene chain has a composition of 50 to 99 wt % of a constituting unit (a) derived from the polyoxyalkylene derivative represented by the following formula (2), 1 to 50 wt % of a constituting unit (b) derived from dicarboxylic acid or maleic anhydride represented by the following formula (3), and optionally 0 to 30 wt % of a constituting unit (c) derived from another copolymerizable monomer.

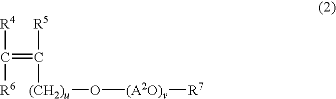

(wherein R⁴, R⁵ and R⁶ each independently represent hydrogen atom or methyl group, A²O represents one or two or more oxyalkylene group having 2 to 4 carbon atoms, which may be block or random in the case of two or more kinds of oxyalkylene groups, R⁷ represents hydrogen atom or a hydrocarbon group having 1 to 22 carbon atom, u=0 to 2, and v=1 to 100.)

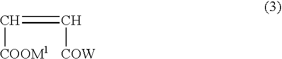

(wherein W represents —OM² or —X-(A³O)_{y} R⁸, X represents an ether group or imino group, A³O represents one or two or more oxyalkylene group each having 2 to 4 carbon atoms, which may be block or random in the case of two or more oxyalkylene groups, R⁸ represents hydrogen atom or a hydrocarbon group having 1 to 22 carbon atoms, M¹ and M² each independently represent hydrogen atom, an alkali metal, an alkaline earth metal, ammonium or an organic ammonium group, and y=1 to 100.)

In a preferred embodiment of the nitrogenous polyoxyalkylene derivative of formula (1), R¹ represents hydrogen atom, R² represents ethylene group, and A¹O is composed of oxyalkylene groups having 2 to 3 carbon atoms with a ratio of oxyalkylene group having 2 carbon atoms to oxyalkylene group having 3 carbon atoms, C2:C3=0 to 60:40 to 100, which may be block or random, p=0 to 10, q=0 to 10, r=1 to 8, s=0 and t=0 and the clouding point of 1% aqueous solution of the nitrogenous polyoxyalkylene derivative is 50° C. or higher.

In another preferred embodiment of the polyoxyalkylene derivative of formula (2), the total of carbon atoms in R⁴, R⁵ and R⁶ is 0 to 1, A²O is composed of oxyalkylene groups having 2 to 3 carbon atoms with a ratio of oxyalkylene group having 2 carbon atoms to oxyalkylene group having 3 carbon atoms, C2:C3=80 to 100:0 to 20, which may be block or random, R⁷ represents hydrogen atom or methyl group, u represents an integer of 1, and v=10 to 90.

The present invention further provides a cement composition comprising fly ash as an essential component, further comprising a blend consisting of water, a cement and an aggregate to which the additive is added.

According to the cement composition of the invention, fly ash can be well dispersed with addition of a small amount of additive to prevent the deviation of flowability of the cement composition due to the change of unburned carbon content.

### BEST MODES FOR CARRYING OUT THE INVENTION

The fly ash-containing cement composition of the invention includes a constituting unit based on the nitrogenous polyoxyalkylene derivative represented by the formula (1) as an essential component.

According to formula (1), R¹ represents hydrogen atom or a hydrocarbon group having 1 to 22 carbon atoms. The hydrocarbon group having 1 to 22 carbon atoms includes aliphatic and saturated hydrocarbon groups such as methyl, ethyl, propyl, isopropyl, butyl, isobutyl, secondary butyl, tertially butyl, pentyl, isopentyl, neopentyl, hexyl, heptyl, octyl, nonyl, decyl, undecyl, dodecyl, isotridecyl, tetradecyl, hexadecyl, isocetyl, octadecyl, stearyl, isostearyl groups etc.; aliphatic and unsaturated hydrocarbon groups such as allyl, metallyl, oleyl groups etc.; alicyclic and saturated hydrocarbon groups such as cyclohexyl, methyl cyclohexyl groups etc.; alicyclic and unsaturated hydrocarbon groups such as cyclopentenyl and cyclohexenyl groups etc.; aromatic hydrocarbon groups or substituted aromatic hydrocarbon groups such as phenyl, benzyl, crezyl, butylphenyl, dibutylphenyl, octylphenyl, nonylphenyl, dodecylphenyl, dioctylphenyl, dinonylphenyl, α-methylbenzylphenyl groups etc., which may be used alone or in combination. It may preferably be hydrogen atom and a hydrocarbon group having 1 to 8 carbon atoms and more preferably be hydrogen atom. In the case that the number of carbon atoms of the hydrocarbon group represented by R¹ exceeds 22, the hydrophilic property is not sufficiently good.

R² represents an alkylene group having 1 to 4 carbon atoms. The alkylene group having 1 to 4 carbon atoms includes methylene, ethylene, propylene, trimethylene, butylene, tetramethylene group or the like, which may be used alone or in combination. Ethylene group is preferred.

In the formula (1), A¹O represents one or two or more oxyalkylene group having 2 to 4 carbon atoms, for example, including oxyethylene group, oxypropylene group and oxybutylene group, which may be block or random in the case of two or more oxyalkylene groups. It preferably represents oxyethylene group and oxypropylene group. The ratio of oxyethylene group to oxypropylene group is more preferably oxyethylene group:oxypropylene group=60 to 0:40 to 100, and further preferably 20 to 0:80 to 100.

In the formula (1), p and q show the addition molar number of oxyalkylene groups having 2 to 4 carbon atoms and each represents 0 to 20, preferably 0 to 10, and more preferably 1 to 5. When the value of p, q exceeds 20, the resulting compound is undesirably increased in viscosity to make the production difficult.

“r” is 1 to 10, preferably 1 to 8, and more preferably 1 to 4.

“s” and “t” are 0 to 2 and preferably 0.

Preferably, p, q, s and t do not take zero at the same time.

The clouding point of 1% aqueous solution of the nitrogenous polyoxyalkylene derivative represented by the formula (1) is preferably 50° C. or higher. The “clouding point” is defined as “a temperature at which a surfactant aqueous solution starts to cloud when the temperature is raised, and phase separation is generally caused with the clouding” in JIS K 3211 “Surfactant Terms”.

The fly ash-containing cement composition of the invention contains the polycarboxylic acid series copolymer having a polyoxyalkylene chain as the essential component.

The polycarboxylic acid series copolymer having a polyoxyalkylene chain used for the invention includes an esterified product of a polyoxyalkylene compound and a copolymer of maleic acid-styrene sulfonic acid or its salt; an esterified product of a polyoxyalkylene compound and a copolymer of maleic anhydride-styrene or its hydrolysate or its salt; an esterified product of a polyoxyalkylene compound and a copolymer of maleic anhydride-olefin or its hydrolysate or its salt; polyoxyalkylene monoalkylether (metha)acrylate-(metha)acrylic acid copolymer or its salt; polyoxyalkylene mono(metha)allylether-maleic acid copolymer or its salt; polyoxyalkylene monoalkyl mono(metha) allyl ether-maleic anhydride copolymer, its hydrolysate or its salt etc.

Among the polycarboxylic acid series compound having a polyoxyalkylene compound at the side chain, the copolymer may preferably be used having a composition of 50 to 99 wt % of the constituting unit (a) based on the polyoxyalkylene derivative represented by the formula (2), 1 to 50 wt % of the constituting unit (b) based on dicarboxylic acid or maleic acid represented by the formula (3), and optionally 0 to 30 wt % of the constituting unit (c) based on another copolymerizable monomer.

In the formula (2), R⁴, R⁵ and R⁶ each represent hydrogen atom or methyl group, and preferably the total of numbers of carbon atoms of R⁴, R⁵ and R⁶ Is 0 to 1. In the formula (2), A²O represents one or two or more oxyalkylene groups having 2 to 4 carbon atoms, for example, including oxyethylene group, oxypropylene group and oxybutylene group, which may be block or random in the case of two or more oxyalkylene groups. It preferably represents oxyethylene group and oxypropylene group, with the ratio of oxyethylene group to oxypropylene group being more preferably oxyethylene group:oxypropylene group=80 to 100:20 to 0, further preferably oxyethylene group:oxypropylene group=90 to 100:10 to 0.

In the formula (2), v shows the addition molar number of oxyalkylene groups having 2 to 4 carbon atoms, and is 1 to 100, preferably 10 to 90, and more preferably 15 to 80. When the value of v exceeds 100, the resulting compound is undesirably increased in viscosity to make the production difficult.

“u” shows the repeat number of methylene groups, and is an integer of 0 to 2 and preferably 1.

The hydrocarbon group having 1 to 22 carbon atoms represented by R⁷ in formula (2) includes aliphatic and saturated hydrocarbon groups such as methyl, ethyl, propyl, isopropyl, butyl, isobutyl, secondary butyl, tertially butyl, pentyl, isopentyl, neopentyl, hexyl, heptyl, octyl, nonyl, decyl, undecyl, dodecyl, isotridecyl, tetradecyl, hexadecyl, isocetyl, octadecyl, stearyl, isostearyl groups etc.; aliphatic and unsaturated hydrocarbon groups such as allyl, metallyl, oleyl etc.; alicyclic and saturated hydrocarbon groups such as cyclohexyl, methyl cyclohexyl etc.; alicyclic and unsaturated hydrocarbon groups such as cyclopentenyl and cyclohexenyl groups etc.; aromatic hydrocarbon groups or substituted aromatic hydrocarbon groups such as phenyl, benzyl, crezyl, butylphenyl, dibutylphenyl, octylphenyl, nonylphenyl, dodecylphenyl, dioctylphenyl, dinonylphenyl, α-methylbenzylphenyl groups etc., which may be used alone or in combination. It may preferably be hydrogen atom and a hydrocarbon group having 1 to 8 carbon atoms and more preferably be methyl group or hydrogen atom. In the case that the number of carbon atoms of the hydrocarbon group represented by R⁷ exceeds 22, the hydrophilic property is not sufficiently good.

In the formula (3), M¹ and M² each represent hydrogen atom, an alkali metal, an alkaline earth metal, an ammonium or an organic ammonium. Examples of the alkali metal include lithium, sodium, potassium and rubidium.

Examples of the alkaline earth metal include magnesium and calcium.

The organic ammonium is an ammonium derived from an organic amine, and examples of the organic amine include alkanolamine such as monoethanolamine, diethanolamine or triethanolamine, and alkylamine such as methylamine, dimethylamine, trimethylamine, ethylamine, diethylamine or triethylamine. Among them, monoethanolamine, diethanolamine, methylamine, ethylamine, dimethylamine and diethylamine are preferred.

In the formula (3), W is —OM² or —X-(A³O)_{y} R⁸. X represents an ether group or imino group, the ether group being —O—, and the imino group being —NH—. “y” shows the addition molar number of oxyalkylene groups having 2 to 4 carbon atoms, and is 1 to 100, preferably 10 to 90, and more preferably 20 to 70. When the value of y exceeds 100, the resulting compound is undesirably increased in viscosity to make the production difficult.

The constituting unit based on another polymerizable monomer for the copolymer with polyoxyalkylene derivative used for the fry ash-containing cement composition of the invention, may be added without deteriorating the effect of the present invention. The examples include vinyl acetate, sodium allylsulfonate, sodium methallylsulfonate, methacrylic acid, and acrylic acid.

The copolymer with polyoxyalkylene derivative used for the fry ash-containing cement composition of the invention is composed of 50 to 99 wt % of the constituting unit (a) based on the polyoxyalkylene derivative represented by the formula (2), 1 to 50 wt % of the constituting unit (b) based on dicarboxylic acid or maleic anhydride represented by the formula (3), and 0 to 30 wt % of the constituting unit (c) based on another copolymerizable monomer. Preferable amounts of (a), (b) and (c) are 80 to 99 wt %, 1 to 20 wt %, and 0 to 20 wt %, respectively.

The copolymer with polyoxyalkylene derivative used for the fry ash-containing cement composition of the invention has a weight average molecular weight of 500 to 100,000, preferably of 5,000 to 50,000. A compound with a weight average molecular weight exceeding 100,000 is undesirable since reduction in the dispersibility as cement-based extrusion molding composition is caused, and an increased viscosity makes the production difficult.

The copolymer with polyoxyalkylene derivative used for the fry ash-containing cement composition of the invention can be obtained by performing polymerization by use of a polymerization initiator according to a known method. The polymerization method may be bulk polymerization or solution polymerization. In solution polymerization using water as solvent, a persulfate such as sodium persulfate, potassium persulfate or ammonium persulfate, hydrogen peroxide, or a water-soluble azo-based initiator can be used, and a promoter such as sodium hydrogen sulfite, hydroxylamine hydrochloride, thiourea, or sodium hypophosphite can be used also in combination therewith. In solution polymerization using a lower alcohol such as methanol, ethanol or isopropanol, an aliphatic hydrocarbon such as n-hexane, 2-ethylhexane or cyclohexane, an aromatic hydrocarbon such as toluene or xylene, or an organic solvent such as acetone, methyl ethyl ketone or ethyl acetate, or in bulk polymerization, an organic peroxide such as benzoyl peroxide, di-t-butyl peroxide or t-butyl peroxiisobutylate or an azo-based compound such as azoisobutyronitrile can be used. In such case, a chain transfer agent such as thioglycolic acid or mercaptoethanol can be used together.

As the inventive additive for a fly ash-containing cement composition, it is used solution containing (A) a nitrogenous polyoxyalkylene derivative represented by the following formula (1) and (B) a polycarboxylic acid series copolymer having a polyoxyalkylene chain. The mixed ratio of (A) and (B) may preferably be 5:95 to 95:5 weight parts (the total is 100 weight parts) and more preferably be 20:80 to 80:20 weight parts (the total is 100 weight parts).

The inventive cement composition further includes a hydraulic material as an essential component. Examples of the hydraulic material include Portland cement such as ordinary, early-strength, moderate heat or belite cement, blended cement obtained by blending the Portland cement and mineral powder such as furnace slag, silica fume, limestone or the like, alumina cement, plaster and the like. These may be used alone or in combination of two or more thereof. The amount of the hydraulic material preferably accounts for, for example, 10 to 50 parts by weight to 100 parts by weight of the blend, although it is not particularly limited.

The inventive cement composition includes an aggregate as the essential component. Examples of the aggregate include fine aggregates and coarse aggregates. The production sites of the fine aggregates are not limited. The fine aggregates include pit sand, river sand, sea sand, crashed sand, fry ash or the like, which may be used alone or in combination. Fry ash is the essential component. The amount of the fine aggregates is not limited, and for example, it may account for 20 to 80 weight parts with respect to 100 weight parts of the blend. The production sites of the coarse aggregates are not limited. The coarse aggregates include crashed gravel, river gravel or the like, which may be used alone or in combination. The amount of the coarse aggregate is not limited, and for example, it may account for 20 to 50 weight parts with respect to 100 weight parts of the blend.

The mixture of (A) and (B) with respect to 100 weight parts of the composition is 0.005 to 2.0 weight parts, and preferably 0.01 to 1.0 weight parts, with respect to the hydraulic material such as cement. In the case that the amount of the mixture of (A) and (B) below the range, the effects of the invention are not obtained. In the case that the amount exceeds the above range, the retardation of setting would easily occur and not preferred.

The amount of water to 100 parts by weight of the composition is 15 to 65 parts by weight. In the case that the amount of water is less than 15 parts by weight, the load in kneading of the extrusion molding composition is undesirably increased to deteriorate the workability.

The inventive additive for fry ash-containing cement composition may be used together with optional another additive so far as the effects are obtained. Such another additive includes other water-reducing agents such as the salt of condensation product of naphthalene sulfonic acid-form aldehyde, the salt of condensation product of melaminesulfonic acid-formaldehyde, the salt of lignin sulfonic acid or the salt of condensation product of aromatic amino sulfonic acid-formaldehyde, air-entraining agent, segregation reducing agent, thickner, waterproofing agent, setting retarder, setting accelerator, quick setting agent, expansion agent, drying shrinkage reducing agent, preservative, forming agent, foaming agent, AE agent, defoaming agent, surfactant, or the like. Further, another additive includes admixture such as high strength additive, high strength admixture and ultra high strength admixture.

In producing the cement composition by the invention, the components and other optional components are added and mixed to prepare the composition by conventional method.

### EXAMPLES

The present invention will be further described in reference to examples. The structural formula of the compound represented by the formula (1) is shown in Table 1, and the structural formula of the compound represented by the formula (2), the structural formula of the compound represented by the formula (3), the copolymerized composition and weight average molecular weight thereof are shown in Table 2.

TABLE 1

| | | Clouding point |
|---|---|---|
| | | of 1% aqueous |
| Produc- | | solution of |
| tion | | compound of |
| Example | Compound represented by formula (1) | formula (1) |
| 1 | 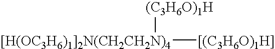 | 100↑ |
| 2 | 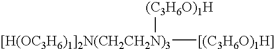 | 100↑ |

TABLE 2

| Produc- | Compound | Compound | Weight average |
|---|---|---|---|
| tion | represented by | represented by | molecular |
| Exam- | formula (2) | formula (3) | weight |
| ple | (weight %) | (weight %) | (by GPC) |
| 3 | H₂C═CHCH₂O— | Maleic acid | 25,500 |
| | (C₂H₄O)₃₃CH3 | 9.7 | |
| | 90.3 | | |
| 4 | H₂C═CHCH₂O(C₃H₆O)₃— | Disodium | 32,800 |
| | (C₂H₄O)₆₅CH₃ | maleate | |
| | 89.6 | 10.4 | |
| 5 | H₂C═CHCH₂O— | Disodium | 20,300 |
| | [(C₃H₆O)₂/(C₂H₄O)₃₂]H | maleate | |
| | 90.1 | 9.9 | |

### Production Example 1

Tetraethylene pentamine 930 g (5.0 moles) was charged into a 5-1 pressure reactor, and the air within the system was substituted by nitrogen gas. Propylene oxide 2030 g (35.0 moles) was gradually added thereto at 100±5° C. with about 0.05 to 0.5 MPa (gauge pressure) to perform the addition reaction. After the completion of the reaction, the reaction mixture was cooled to 60° C. The clouding point of 1% aqueous solution of the resulting nitrogenous polyoxyalkylene derivative was higher than 50° C. (100° C. or higher).

### Production Example 2

The same reaction as in Production Example 1 was performed using triethylene tetramine to thereby obtain a nitrogenous polyoxyalkylene derivative. The clouding point of 1% aqueous solution of the nitrogenous polyoxyalkylene derivative was higher than 50° C. (100° C. or higher).

### Production Example 3

Polyoxyethylene (average addition molar number of ethyleneoxide 33) monoallyl monomethyl ether 1524 g (1 mole) and maleic anhydride 107.8 g (1.1 mole) were charged into a 3-1 flask installed with an agitator, a thermometer, a nitrogen gas inlet tube and a reflux cooler. Tert-butyl peroxy-2-ethylhexanoate 9.7 g was added thereto as a polymerization initiator at 60° C. in nitrogen atmosphere, and the temperature was elevated to 85±2° C. for performing the reaction for 8 hours. The thus obtained copolymer had a weight average molecular weight of 25500 and a dynamic viscosity of 224 mm²/s at 100° C. The mixture was cooled at 60° C. or lower and 1094 g of water was added thereto to obtain 60% aqueous solution of the copolymer.

### Production Example 4

32 g of methanol and 0.3 g of sodium methoxide as a catalyst were charged into a 5-liter pressure reactor. Air in the system was replaced with nitrogen gas, and 2860 g of ethylene oxide was gradually added thereto under pressure at 0.05 to 0.5 MPa (gauge pressure) at 100 to 120° C. to perform the addition reaction. Thereafter, 174 g of propylene oxide was gradually added thereto under pressure at 90 to 110° C. at 0.05 to 0.5 MPa (gauge pressure) to perform the addition reaction. After the completion of the reaction, the mixture was cooled to 50° C. 56 g of potassium hydroxide was then added and air in the system was replaced with nitrogen gas. 76.5 g of allyl chloride was gradually added thereto with stirring at 80° C. After 6 hours of stirring, the reaction was terminated. The mixture was neutralized with hydrochloric acid and the salt as the byproduct was removed to obtain the polyoxyalkylene compound represented by formula (2) shown in table 2.

1533 g (0.5 mol) of the compound of formula (2) and 58.8 g (0.6 mol) of maleic anhydride were charged into a 3-1 flask installed with an agitator, a thermometer, a nitrogen gas inlet tube and a reflux cooler. 8.2 g of 2,2′-azobisisobutyronitril was added thereto as a polymerization initiator below 60° C. in nitrogen atmosphere, and the temperature was elevated to 85±2° C. for performing the reaction for 8 hours. The thus obtained copolymer had a weight average molecular weight of 32800 and a dynamic viscosity of 753 mm²/s at 100° C. The mixture was cooled at 60° C. or lower and 1067 grams of water was added thereto to obtain 60% aqueous solution of the copolymer.

### Production Example 5

Polyoxyethylene oxypropylene (average addition molar number of ethyleneoxide 32: average addition molar number of propylene oxide 2: random copolymer) monoallyl ether 1524 g (1 mole), maleic anhydride 147 g (1.5 mole) and water 1114 g were charged into a 3-1 flask installed with an agitator, a thermometer, a nitrogen gas inlet tube and a reflux cooler. 13.7 g of ammonium persulfate was added thereto as a polymerization initiator at 40° C. or lower under nitrogen gas atmosphere, and the temperature was elevated at 70±5° C. for performing the reaction for 8 hours. The thus obtained copolymer had a weight average molecular weight of 20300.

### Example 1

In a test room at 20° C., a 5-liter mortar mixer was used to knead cement (ordinary Portland cement), fly ash (1) (JIS Type II: ig. loss:1.90) or fly ash (2) (JIS Type II: ig. loss:2.59) and fine aggregate (river sand produced in Ooi river: specific gravity of 2.58) shown in table 3 for 30 seconds. 1.2 g of the nitrogenous polyoxyalkylene derivative of (A) obtained in the production example 1, 6.0 g of the polycarboxylic acid series copolymer having polyoxyalkylene chain of (B) obtained in the production example 3 (as 20% aqueous solution) and anti-foaming agent (Disfoam CC-118: produced by NOF Corporation) were dissolved into a predetermined amount of water to obtain solution. The solution was added into the mixture and then kneaded for 60 seconds at a low rate and for 2 minutes at a high rate. The added amount was adjusted so that the mortar flow just after the kneading was 240±10 cm in the case that fry ash (1) is used. The mortar flow just after the kneading was measured. It was confirmed that the air amount was 2.0±1.5% and the temperature was 20±2° C. just after the kneading. The difference of the mortar flows, in the cases of the fry ash (1) used and of the fry ash (2) used was evaluated to confirm the deviation of the mortar flows due to the unburned carbon content. The thus obtained results were shown in table 4.

TABLE 3

| | | | Nitrogenous | Polycarboxylic acid series | Amount used for 1 batch (g) | | | | |
|---|---|---|---|---|---|---|---|---|---|
| | | | polyoxyalkylene | copolymer having | | | Fry | Fry | |
| | W/P | S/P | derivative of (A) | polyoxyalkylene chain of | | | ash | ash | |
| | (%) | (%) | (P × %) | (B) (P × %) | W | C | (1) | (2) | S |
| Ex. 1 | 32.4 | 1.536 | Production Example 1 | Production Example 3 | 162 | 400 | 100 | — | 768 |
| | 32.4 | 1.536 | 0.24 | 1.2 | 162 | 400 | — | 100 | 768 |
| Ex. 2 | 32.4 | 1.536 | Production Example 2 | Production Example 5 | 162 | 400 | 100 | — | 768 |
| | 32.4 | 1.536 | 0.36 | 1.2 | 162 | 400 | — | 100 | 768 |
| Ex. 3 | 32.4 | 1.536 | Production Example 1 | Production Example 5 | 162 | 400 | 100 | — | 768 |
| | 32.4 | 1.536 | 0.10 | 1.2 | 162 | 400 | — | 100 | 768 |
| Ex. 4 | 32.4 | 1.536 | Production Example 2 | Production Example 4 | 162 | 400 | 100 | — | 768 |
| | 32.4 | 1.536 | 0.16 | 1.2 | 162 | 400 | — | 100 | 768 |
| Com. | 32.4 | 1.536 | — | Production Example 4 | 162 | 400 | 100 | — | 768 |
| Ex. 1 | 32.4 | 1.536 | | 1.2 | 162 | 400 | — | 100 | 768 |
| Com. | 32.4 | 1.536 | Polyoxyethylene | Production Example 3 | 1.62 | 400 | 100 | — | 768 |
| Ex. 2 | 32.4 | 1.536 | (20 mol) | 1.2 | 162 | 400 | — | 100 | 768 |
| | | | octadecylarnine | | | | | | |
| | | | 0.24 | | | | | | |

Materials used
W: service water C: ordinary cement specific gravity = 3.15 P: C + fry ash
Fry ash (1): JIS II type (Ig. loss: 1.90) specific gravity = 2.26
Fry ash (2): JIS II type (Ig. loss: 2.59) specific gravity = 2.26
S: pit sand produced in Ooi river Specific gravity = 2.58

1: it is shown the added amount of 20% aqueous solution of the polycarboxylic acid series copolymer having polyoxyalkylene chain represented by formula (B), according to the invention.

TABLE 4

| | | | Mortar flow | Difference due to |
|---|---|---|---|---|
| | Cement | Kind of | Direct after | Kind of fry ash |
| | Additive | Fry ash | Kneading (cm) | (\textcircled{1}-\textcircled{2}) |
| Example 1 | Blend 1 | \textcircled{1} | 240 | 15 |
| | | \textcircled{2} | 225 | |
| Example 2 | Blend 2 | \textcircled{1} | 238 | 13 |
| | | \textcircled{2} | 225 | |
| Example 3 | Blend 3 | \textcircled{1} | 240 | 20 |
| | | \textcircled{2} | 220 | |
| Example 4 | Blend 4 | \textcircled{1} | 242 | 17 |
| | | \textcircled{2} | 225 | |
| Comparative | Blend 4 | \textcircled{1} | 240 | 40 |
| Example 1 | | \textcircled{2} | 200 | |
| Comparative | Blend 5 | \textcircled{1} | 238 | 33 |
| Example 2 | | \textcircled{2} | 205 | |

### Examples 2 to 4

The nitrogenous polyoxyalkylene derivatives of (A) obtained in the production examples 1 and 2 and the polycarboxylic acid series copolymers each having polyoxyalkylene chain of (B) obtained in the production examples 3 to 5 were used to perform the mortar test, according to the same procedure as the example 1 and the amounts shown in table 3. The thus obtained results were shown in table 4.

### Comparative Example 1

The nitrogenous polyoxyalkylene derivatives of (A) was not used and 6.0 g of the polycarboxylic acid series copolymer having polyoxyalkylene chain of (B) obtained in the production example 4 (as 20% aqueous solution) and anti-foaming agent were used to perform the mortar test, according to the same procedure as the example 1. The thus obtained results were shown in table 4.

### Comparative Example 2

1.2 g of polyoxyethylene (20 mol) octadecylamine as the nitrogenous polyoxyalkylene derivative, 6.0 g of the polycarboxylic acid series copolymer having polyoxyalkylene chain of (B) obtained in the production example 3 (as 20% aqueous solution) and anti-foaming agent were used to perform the mortar test, according to the same procedure as the example 1. The thus obtained results were shown in table 4.

As can be seen from the above results, by comparing the examples 1 to 4 and comparative examples 1 and 2, it was proved that the inventive additive for fry ash-containing cement composition was not susceptible to the difference of unburned carbon contents of fry ash so that the deviation of mortar flow, that is, water-reducing property was reduced.

As described above, according to the invention, fly ash can be well dispersed with addition of a small amount of additive to prevent the deviation of flowability of the cement composition due to the change of unburned carbon content.

While specific embodiments have been shown and described, the present invention is never limited by these specific embodiments and can be carried out with various modifications and substitutions without departing from the scope of the claims.

1. An additive for a fly ash-containing cement composition, said additive comprising the following components (A) and (B) as essential components, wherein said component (A) is present in a ratio of 5 weight parts or more and 95 weight parts or less provided that 100 weight parts are assigned to the total weight of the components (A) and (B).
Component (A): a nitrogenous polyoxyalkylene derivative represented by the following formula (1).
Component (B): a polycarboxylic acid series copolymer having a polyoxyalkylene chain. 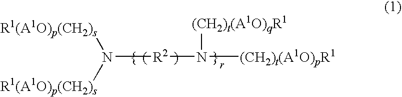
(wherein R¹ represents hydrogen atom or a hydrocarbon group having 1 to 22 carbon atom, R² represents an alkylene group having 1 to 4 carbon atom, A¹O represents one or two or more oxyalkylene group having 2 to 4 carbon atoms, which may be block or random in the case of two or more kinds of oxyalkylene groups, p=0 to 20, q=0 to 20, r=1 to 10, s=0 to 2 and t=0 to 2.)

2. The additive of claim 1, wherein said component (B) has a composition of 50 to 99 wt % of a constituting unit (a) represented by the following formula (2), 1 to 50 wt % of a constituting unit (b) based on dicarboxylic acid or maleic anhydride represented by the following formula (3), and optionally 0 to 30 wt % of a constituting unit (c) based on another copolymerizable monomer. 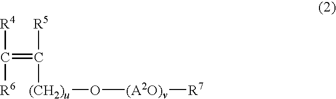
(wherein R⁴, R⁵ and R⁶ each independently represent hydrogen atom or methyl group, A²O represents one or two or more oxyalkylene group having 2 to 4 carbon atoms, which may be block or random in the case of two or more kinds of oxyalkylene groups, R⁷ represents hydrogen atom or a hydrocarbon group having 1 to 22 carbon atom, u is an integer of 0 to 2, and v=1 to 100.) 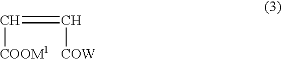
(wherein W represents —OM² or —X-(A³O)_{y} R⁸, X represents an ether group or imino group, A³O represents one or two or more oxyalkylene group each having 2 to 4 carbon atoms, which may be block or random in the case of two or more oxyalkylene groups, R⁸ represents hydrogen atom or a hydrocarbon group having 1 to 22 carbon atom, M¹ and M² each independently represent hydrogen atom, an alkali metal, an alkaline earth metal, ammonium or an organic ammonium group, and y=1 to 100.)

3. The additive of claim 1, wherein R¹ represents hydrogen atom, R² represents ethylene group, and A¹O is composed of oxyalkylene groups having 2 to 3 carbon atoms with a ratio of oxyalkylene group having 2 carbon atoms to oxyalkylene group having 3 carbon atoms, C2:C3=0 to 60:40 to 100, which may be block or random, p=0 to 10, q=0 to 10, r=1 to 8, s=0 and t=0 in the formula (1) and wherein 1% aqueous solution of the nitrogenous polyoxyalkylene derivative has a clouding point of 50° C. or higher.

4. The additive of claim 2, wherein the total of carbon atoms in R⁴, R⁵ and R⁶ is 0 to 1, A²O is composed of oxyalkylene groups having 2 to 3 carbon atoms with a ratio of oxyalkylene group having 2 carbon atoms to oxyalkylene group having 3 carbon atoms, C2:C3=80 to 100:0 to 20, which may be block or random, R⁷ represents hydrogen atom or methyl group, u=1, and v=10 to 90 in the formula (2).

5. A cement composition comprising fly ash, water, a hydraulic material, an aggregate and said additive of claim 1.

6. The additive of claim 2, wherein R¹ represents hydrogen atom, R² represents ethylene group, and A¹O is composed of oxyalkylene groups having 2 to 3 carbon atoms with a ratio of oxyalkylene group having 2 carbon atoms to oxyalkylene group having 3 carbon atoms, C2:C3=0 to 60:40 to 100, which may be block or random, p=0 to 10, q=0 to 10, r=1 to 8, s=0 and t=0 in the formula (1) and wherein 1% aqueous solution of the nitrogenous polyoxyalkylene derivative has a clouding point of 50° C. or higher.

7. The additive of claim 3, wherein the total of carbon atoms in R⁴, R⁵ and R⁶ is 0 to 1, A²O is composed of oxyalkylene groups having 2 to 3 carbon atoms with a ratio of oxyalkylene group having 2 carbon atoms to oxyalkylene group having 3 carbon atoms, C2:C3=80 to 100:0 to 20, which may be block or random, R⁷ represents hydrogen atom or methyl group, u=1, and v=10 to 90 in the formula (2).

8. The additive of claim 6, wherein the total of carbon atoms in R⁴, R⁵ and R⁶ is 0 to 1, A²O is composed of oxyalkylene groups having 2 to 3 carbon atoms with a ratio of oxyalkylene group having 2 carbon atoms to oxyalkylene group having 3 carbon atoms, C2:C3=80 to 100:0 to 20, which may be block or random, R⁷ represents hydrogen atom or methyl group, u=1, and v=10 to 90 in the formula (2).

9. A cement composition comprising fly ash, water, a hydraulic material, an aggregate and said additive of claim 2.

10. A cement composition comprising fly ash, water, a hydraulic material, an aggregate and said additive of claim 3.

11. A cement composition comprising fly ash, water, a hydraulic material, an aggregate and said additive of claim 6.

12. A cement composition comprising fly ash, water, a hydraulic material, an aggregate and said additive of claim 4.

13. A cement composition comprising fly ash, water, a hydraulic material, an aggregate and said additive of claim 7.

14. A cement composition comprising fly ash, water, a hydraulic material, an aggregate and said additive of claim 8.
